(19) United States
(12) Patent Application Publication
(10) Pub. No.: US 2021/0218260 A1
(43) Pub. Date: Jul. 15, 2021

(54) RECHARGEABLE BATTERY PROTECTION APPARATUS

(71) Applicant: Hilti Aktiengesellschaft, Schaan (LI)

(72) Inventors: Michael NITZSCHNER, Augsburg (DE); Michael CANDUSSIO, Calw (DE); Rene Richter, Augsburg (DE); Andreas GUGGEMOS, Bad Woerishofen (DE)

(21) Appl. No.: 17/058,950

(22) PCT Filed: Jul. 1, 2019
(86) PCT No.: PCT/EP2019/067516

§ 371 Date: Nov. 25, 2020

(30) Foreign Application Priority Data
Jul. 9, 2018 (EP) 18182397.2

(51) Int. Cl. H02J 7/00; H01M 10/42; H01M 50/583

(52) U.S. Cl. CPC H02J 7/00308; H01M 10/4257; H01M 2200/103; H02J 7/0047; H01M 50/583

(57) ABSTRACT

Protective apparatus for protecting a rechargeable battery pack including at least one rechargeable battery cell against an overvoltage in at least one line of the rechargeable battery pack. Method for protecting a rechargeable battery pack against an overvoltage, wherein the rechargeable battery pack includes at least one rechargeable battery cell and also a protective apparatus including a fuse device including at least one fuse, a short-circuiting line for optionally short-circuiting the at least one rechargeable battery cell by way of the at least one fuse, a monitoring device including at least one voltage comparator and at least one switch for optionally closing the short-circuiting line.

The present invention relates to a protective apparatus for protecting a rechargeable battery pack comprising at least one rechargeable battery cell against an overvoltage in at least one line of the rechargeable battery pack.

Furthermore, the present invention relates to a method for protecting a rechargeable battery pack against an overvoltage, wherein the rechargeable battery pack comprises at least one rechargeable battery cell and also a protective apparatus comprising a fuse device comprising at least one fuse, a short-circuiting line for optionally short-circuiting the at least one rechargeable battery cell by way of the at least one fuse, a monitoring device comprising at least one voltage comparator and at least one switch for optionally closing the short-circuiting line.

### BACKGROUND

Rechargeable battery packs, referred to as rechargeable batteries, are known in principle from the prior art. Modern rechargeable battery packs are equipped with a protective apparatus in order to protect the rechargeable battery cells present in the rechargeable battery pack from an excessively high voltage value. However, such protective apparatuses for protecting a rechargeable battery pack against an overvoltage which are known from the prior art often have the problem that they are relatively large, complex and expensive.

### SUMMARY OF THE INVENTION

It is an object of the present invention to provide a protective apparatus for protecting a rechargeable battery pack comprising at least one rechargeable battery cell against an overvoltage and also a method for protecting a rechargeable battery pack comprising at least one rechargeable battery cell against an overvoltage in order to solve the problem described above.

The present invention provides a protective apparatus for protecting a rechargeable battery pack comprising at least one rechargeable battery cell against an overvoltage in at least one line of the rechargeable battery pack.

According to the invention, the protective apparatus comprises a fuse device comprising at least one fuse, a short-circuiting line for optionally short-circuiting the at least one rechargeable battery cell by way of the at least one fuse, and a monitoring device comprising at least one voltage comparator for detecting an exceedance of a voltage threshold value by a voltage value detected by the monitoring device, and at least one switch for optionally closing the short-circuiting line if the voltage value detected by the voltage comparator exceeds the voltage threshold value by a predetermined voltage value for a predetermined time duration, such that a current flowing through the at least one fuse exceeds a short-circuit current value of the at least one fuse, as a result of which the at least one fuse interrupts the at least one line of the rechargeable battery pack. The short-circuit current value can also be referred to as rated current or rated current value.

In accordance with one advantageous configuration, it is possible for the at least one fuse to be configured as a fusible link.

According to a further advantageous configuration, it is possible for the protective apparatus to comprise a printed circuit board having at least one through hole for thermally separating the fuse device and the monitoring device. The thermal conductivity of the printed circuit board can be interrupted or at least reduced by the through hole.

In accordance with a further advantageous configuration, it is possible for the at least one switch to be configured as a transistor.

According to a further advantageous configuration, it is possible for at least one switch to be provided for each fuse.

In accordance with a further advantageous configuration, it is possible for the fuse device to be positioned in the positive line or in the negative line of the rechargeable battery pack.

The present invention also provides a method for protecting a rechargeable battery pack against an overvoltage, wherein the rechargeable battery pack comprises at least one rechargeable battery cell, a fuse device comprising at least one fuse, a short-circuiting line for optionally short-circuiting the at least one rechargeable battery cell by way of the at least one fuse, a monitoring device comprising at least one voltage comparator and at least one switch for optionally closing the short-circuiting line.

According to the invention, the method comprises at least the method steps of
detecting an exceedance of a voltage threshold value by a voltage value detected by the monitoring device with the aid of the voltage comparator, and
closing the short-circuiting line if the voltage value detected by the voltage comparator exceeds the voltage threshold value by a predetermined voltage value for a predetermined time duration, such that a current flowing through the at least one fuse exceeds a short-circuit current value of the at least one fuse, as a result of which the at least one fuse interrupts the at least one line of the rechargeable battery pack.

Further advantages are evident from the following description of the figures. Various exemplary embodiments of the present invention are illustrated in the figures. The figures, the description and the claims contain numerous features in combination. A person skilled in the art will expediently also consider the features individually and combine them to produce expedient further combinations.

BRIEF DESCRIPTION

In the figures, identical components and components of identical type are designated by identical reference signs. In the figures:

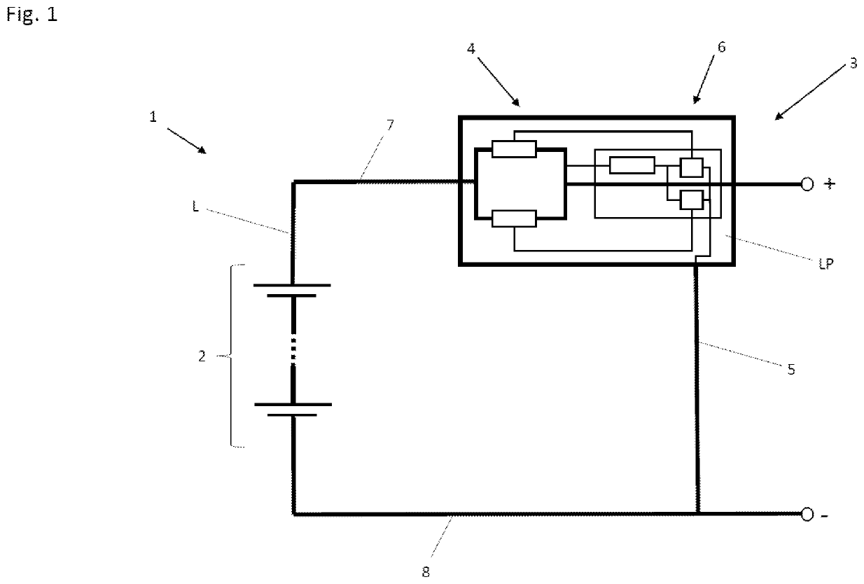

FIG. 1 shows a schematic circuit diagram of a protective apparatus according to the invention in accordance with first configuration;

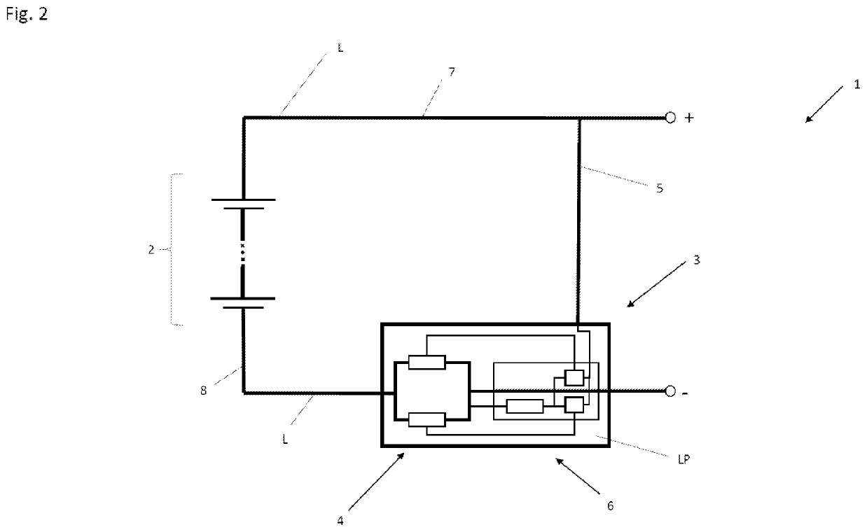

FIG. 2 shows a further schematic circuit diagram of the protective apparatus according to the invention in accordance with a second configuration;

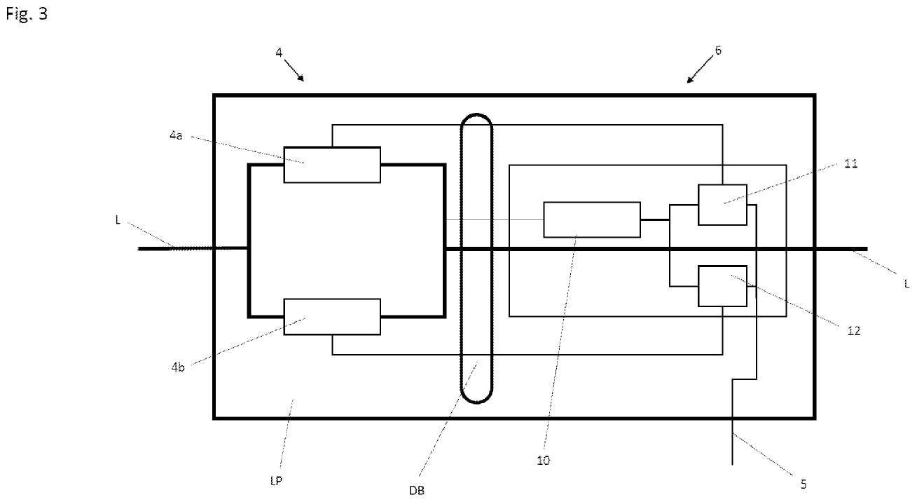

FIG. 3 shows a detail view of the protective apparatus according to the invention with a fuse device, a monitoring device and one through hole;

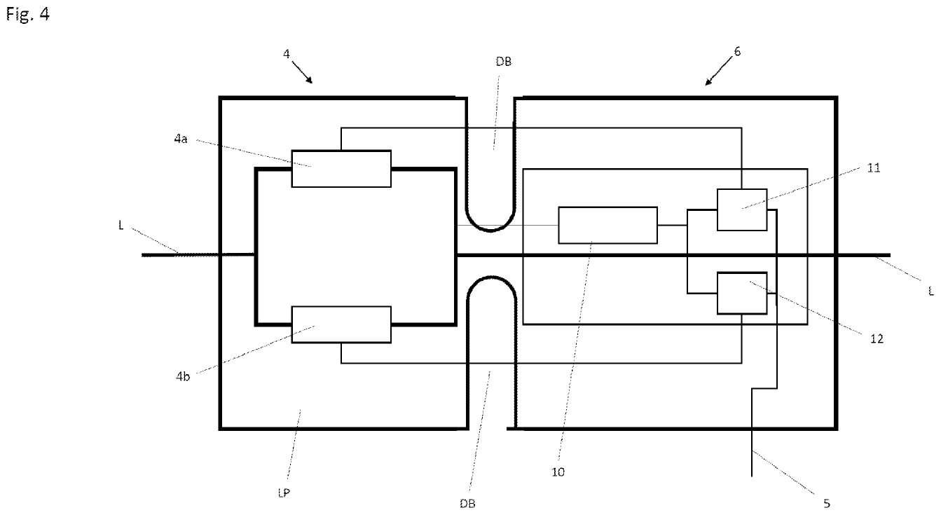

FIG. 4 shows a detail view of the protective apparatus according to the invention with a fuse device, a monitoring device and two through holes.

### DETAILED DESCRIPTION

FIG. 1 shows a schematic illustration of a rechargeable battery pack 1 comprising a multiplicity of rechargeable battery cells 2 and a first embodiment of a protective apparatus 3 according to the invention for protecting the rechargeable battery pack 1 against an overvoltage. The rechargeable battery pack 1 can also be referred to as a rechargeable battery or a battery. Moreover, the rechargeable battery cells 2 can also be referred to as secondary cells.

In this case, the rechargeable battery pack 1 can serve for supplying a machine tool with electrical energy. The machine tool may be, for example, a drill, a screwdriver, a saw, a grinder or the like. The machine tool is not shown in the figures.

In this case, the protective apparatus 3 substantially comprises a fuse device 4, a short-circuiting line 5 and a monitoring device 6.

As illustrated in FIG. 1, the protective apparatus 3 can be positioned either in the positive line 7 or in the negative line 8 of the rechargeable battery pack 1. In accordance with a further configuration (not shown), a protective apparatus 4 can in each case be positioned in the either in the positive line 7 and in the negative line 8 of the rechargeable battery pack.

The fuse device 4 in turn comprises a first fuse 4a and a second fuse 4b (see FIG. 3). As illustrated in the figures, the first fuse 4a and the second fuse 4b are connected in parallel with one another. The first and second fuses 4a, 4b are configured as fusible links. However, it is also possible that any other suitable type of overcurrent protective device can be used for the configuration of the fuse 4a, 4b.

In accordance with one alternative configuration, the fuse device 4 can also comprise more or fewer than two fuses. In this case, the fuses can be interconnected in parallel or else in series with one another.

As shown in the figures, the monitoring device 6 substantially comprises a voltage comparator 10, a first switch 11 and a second switch 12. Both the first switch 11 and second switch 12 here are configured in each case in the form of a transistor. It should be noted that, in accordance with one advantageous configuration of the monitoring device 6, a switch 11, 12 is provided for each fuse 4a, 4b. In accordance with a further alternative configuration of the monitoring device 6, however, it can also be provided that just a single switch 11, 12 be provided for the first and second fuses 4a, 4b. In accordance with this configuration, however, it is also possible for a switch 11, 12 to be assigned to more than two fuses 4a, 4b. According to a further alternative configuration of the monitoring device 6, however, it can in turn be provided that two or more switches 11, 12 are provided for just a single fuse 4a, 4b. This configuration of the monitoring device 6 is advantageous in particular if the short-circuit current has or may have a relatively high value and it is to be feared that a single switch 11, 12 cannot withstand the high short-circuit current and may break down.

The use of at least one switch 11, 12 is absolutely necessary, however. With regard to the quantitative ratio between switch 11, 12 and fuse 4a, 4b, however, it should be noted that the number of switches 11, 12 must correspond at least to the number of fuses 4a, 4b. A higher number of switches 11, 12 in comparison with fuses 4a, 4b is always possible here.

The monitoring device 6 is provided in particular, but not exclusively, for monitoring the values of the electrical voltage which are present in the rechargeable battery or in the rechargeable battery cell 2. For this purpose, the voltage comparator 10 is connected to both the first and the second fuse 4a, 4b together with the rechargeable battery cells and serves for ascertaining that an electrical voltage present in the rechargeable battery cells 2 exceeds a predetermined voltage threshold value.

The short-circuiting line 5 is part of a short-circuiting circuit and serves for short-circuiting the rechargeable battery cells 2. As illustrated in FIGS. 3 and 4, in particular, the short-circuiting line 5 is connected to the first fuse 4a via the first switch 11 and to the second fuse 4b via the second switch 12.

Both the first and the second switch 11, 12 are in each case connected to the voltage comparator 10 and serve for optionally closing or connecting the short-circuiting line 5, as a result of which the rechargeable battery cells 2 are correspondingly short-circuited by way of either the first or the second fuse 4a, 4b. As a result of the rechargeable battery cells 2 being short-circuited with the aid of the short-circuiting line 5, an electric current can flow through the first or second fuse 4a, 4b, said electric current exceeding the short-circuit current value of the respective fuse 4a, 4b, with the result that the fuse 4a, 4b configured as a fusible link melts and interrupts the electrical line L.

If an excessively high electric current flows through the first and/or the second fuse 4a, 4b for example on account of a malfunction of the rechargeable battery pack 1, the voltage present in the first and/or the second fuse 11, 12 rises accordingly. The voltage comparator 10 connected to the first and second fuses 4a, 4b compares the voltage value present in the rechargeable battery cells 2 with a predetermined voltage threshold value stored for this purpose in the voltage comparator 10. If the voltage value present in the rechargeable battery cells 2 exceeds the predetermined voltage threshold value for a predetermined time duration and also by a predetermined value, the voltage comparator 10 transmits a corresponding signal to the first and/or the second switch 11, 12. As a result of the signal transmitted by the voltage comparator 10, for example the first switch 11 is closed, with the result that the rechargeable battery cells 2 are short-circuited by the first fuse 4a by means of the short-circuiting line 5. As a result of the short-circuiting, the value of the current flowing through the first fuse 4a rises above the short-circuit current value of the first fuse 4a, with the result that the fuse configured as a fusible link melts.

As can be gathered from FIG. 3, the protective apparatus 3 comprises a printed circuit board LP having an elongate through hole DB. The through hole DB can also be referred to as a cutout in the printed circuit board LP and serves for thermally separating the fuse device 4 and the monitoring device 6. As a result of the interruption of the printed circuit board LP In the form of the through hole DB, less heat is conducted from the fuses to the thermally sensitive voltage comparator 10. In other words: the through hole serves as a boundary between the fuse device 4 and the monitoring device 6.

Given a length of the printed circuit board LP of 30 mm and a height of 10 mm, the through hole DB has a width of approximately 1 mm and a length of approximately 7 mm.

As shown in FIG. 4, the printed circuit board LP can also have a first and a second through hole DB configured as cutouts. In accordance with an alternative embodiment (not shown in the figures), the printed circuit board LP can also comprise more than two through holes DP.

What is claimed is:

1 to 7. (canceled)

8. A protective apparatus for protecting a rechargeable battery pack having at least one rechargeable battery cell against an overvoltage in at least one line of the rechargeable battery pack, the protective apparatus comprising:
a fuse device including at least one fuse;
a short-circuiting line for optionally short-circuiting the at least one rechargeable battery cell by way of the at least one fuse; and
a monitoring device including at least one voltage comparator for detecting an exceedance of a voltage threshold value by a voltage value detected by the monitoring device, and at least one switch for optionally closing the short-circuiting line if the voltage value detected by the voltage comparator exceeds the voltage threshold value by a predetermined voltage value for a predetermined time duration, such that a current flowing through the at least one fuse exceeds a short-circuit current value of the at least one fuse, the at least one fuse as a result interrupting the at least one line of the rechargeable battery pack.

9. The protective apparatus as recited in claim 8 wherein the at least one fuse is configured as a fusible link.

10. The protective apparatus as recited in claim 8 further comprising a printed circuit board having at least one through hole for thermally separating the fuse device and the monitoring device.

11. The protective apparatus as recited in claim 8 wherein the at least one switch is configured as a transistor.

12. The protective apparatus as recited in claim 8 wherein at least one of the at least one switch is provided for each of the at least one fuse.

13. The protective apparatus as recited in claim 8 wherein the fuse device is positioned in the positive line of the rechargeable battery pack.

14. The protective apparatus as recited in claim 8 wherein the fuse device is positioned in the negative line of the rechargeable battery pack.

15. A method for protecting a rechargeable battery pack against an overvoltage, the rechargeable battery pack including at least one rechargeable battery cell and a protective apparatus including: a fuse device having at least one fuse, a short-circuiting line for optionally short-circuiting the at least one rechargeable battery cell by way of the at least one fuse, and a monitoring device having at least one voltage comparator and at least one switch for optionally closing the short-circuiting line, the method comprising the steps of:
detecting an exceedance of a voltage threshold value by a voltage value detected by the monitoring device with the aid of the voltage comparator; and
closing the short-circuiting line if the voltage value detected by the voltage comparator exceeds the voltage threshold value by a predetermined voltage value for a predetermined time duration, such that a current flowing through the at least one fuse exceeds a short-circuit current value of the at least one fuse, the at least one fuse as a result interrupting the at least one line of the rechargeable battery pack.
